(19) United States
(12) Patent Application Publication
(10) Pub. No.: US 2025/0173248 A1
(43) Pub. Date: May 29, 2025

(54) TEST SUPPORT APPARATUS, SYSTEM, AND METHOD, AND COMPUTER-READABLE MEDIUM

(71) Applicant: NEC Corporation, Minato-ku, Tokyo (JP)

(72) Inventor: Yuhei OKADA, Tokyo (JP)

(73) Assignee: NEC Corporation, Minato-ku, Tokyo (JP)

(21) Appl. No.: 18/839,824

(22) PCT Filed: Feb. 28, 2022
(86) PCT No.: PCT/JP2022/008428

§ 371 Date: Aug. 20, 2024

(51) Int. Cl. G06F 11/3668

(52) U.S. Cl. CPC G06F 11/3688; G06F 11/3684

(57) ABSTRACT

A test support apparatus includes a specifying unit that refers to a database in which each of a plurality of pieces of configuration information constituting an information system and a set of a test program and a test environment corresponding to each piece of the configuration information are registered in association with each other and specifies the set of the test program and the test environment associated with the detected configuration information when an update of some of the plurality of pieces of configuration information constituting the information system is detected, a construction unit that constructs the specified test environment on a virtual system, a deployment unit that deploys a partial information system related to the detected configuration information to the constructed test environment, and a test execution unit that executes the specified test program on the partial information system deployed in the test environment.

### TECHNICAL FIELD

The present invention relates to a test support apparatus, a system, a method, and a program.

### BACKGROUND ART

With the development of cloud systems and virtual container technologies, there is no need to procure a physical device, and a lead time of environment construction of an information system is dramatically reduced. As a result, environment construction can be performed at high speed.

Patent Literature 1 discloses a technique for automating a fault test for a system including a plurality of virtual servers and a virtual network.

### CITATION LIST

### Patent Literature

Patent Literature 1: Japanese Unexamined Patent Application Publication No. 2021-047928

### SUMMARY OF INVENTION

### Technical Problem

Here, at the site of operation and maintenance of the information system, it is common to construct a test environment in addition to a commercial environment in which the information system is actually operated. However, it is not realistic to constantly maintain and operate the test environment having the same configuration as the commercial environment due to the magnitude of the cost disadvantage. Therefore, there is a problem that it is difficult to efficiently perform a test at the time of updating the information system.

In view of the above-described problems, an object of the present disclosure is to provide a test support apparatus, a system, a method, and a program for efficiently constructing a test environment of an information system and performing a test.

### Solution to Problem

A test support apparatus according to a first aspect of the present disclosure includes:
a specifying means for, when an update of some of a plurality of pieces of configuration information constituting an information system is detected, referring to a database in which each of the plurality of pieces of configuration information constituting the information system and a set of a test program and a test environment corresponding to each piece of the configuration information are registered in association with each other and specifying the set of the test program and the test environment associated with the detected configuration information;
a construction means for constructing the specified test environment on a virtual system;
a deployment means for deploying a partial information system related to the detected configuration information to the constructed test environment; and
a test execution means for executing the specified test program on the partial information system deployed in the test environment.

A test support system according to a second aspect of the present disclosure includes:
a database in which each of a plurality of pieces of configuration information constituting an information system and a set of a test program and a test environment corresponding to each piece of configuration information are registered in association with each other; and
a test support apparatus connected to the database,
in which the test support apparatus includes
a specifying means for, when an update of some of the plurality of pieces of configuration information is detected, referring to the database to specify a set of a test program and a test environment associated with the detected configuration information,
a construction means for constructing the specified test environment on a virtual system,
a deployment means for deploying a partial information system related to the detected configuration information to the constructed test environment, and
a test execution means for executing the specified test program on the partial information system deployed in the test environment.

A test support method according to a third aspect of the present disclosure includes:
referring, when an update of some of a plurality of pieces of configuration information constituting an information system is detected, to a database in which each of the plurality of pieces of configuration information constituting the information system and a set of a test program and a test environment corresponding to each piece of the configuration information are registered in association with each other and specifying the set of the test program and the test environment associated with the detected configuration information;
constructing the specified test environment on a virtual system;
deploying a partial information system related to the detected configuration information to the constructed test environment; and
executing the specified test program on the partial information system deployed in the test environment.

A test support program according to a fourth aspect of the present disclosure causes a computer to execute:
specifying processing of, when an update of some of a plurality of pieces of configuration information constituting an information system is detected, referring to a database in which each of the plurality of pieces of configuration information constituting the information system and a set of a test program and a test environment corresponding to each piece of the configuration information are registered in association with each other and specifying the set of the test program and the test environment associated with the detected configuration information;
construction processing of constructing the specified test environment on a virtual system;
deployment processing of deploying a partial information system related to the detected configuration information to the constructed test environment; and
test execution processing of executing the specified test program on the partial information system deployed in the test environment.

### Advantageous Effects of Invention

According to the present disclosure, it is possible to provide a test support apparatus, a system, a method, and a program for efficiently constructing a test environment of an information system and performing a test.

### BRIEF DESCRIPTION OF DRAWINGS

FIG. 1 is a block diagram illustrating a configuration of a test support apparatus according to a first example embodiment.

FIG. 2 is a flowchart illustrating a flow of a test support method according to the first example embodiment.

FIG. 3 is a block diagram illustrating an overall configuration including a test support system according to a second example embodiment.

FIG. 4 is a diagram for explaining a relationship between a commercial environment and a test environment according to the second example embodiment.

FIG. 5 is a diagram illustrating an example of test support information according to the second example embodiment.

FIG. 6 is a diagram illustrating an example of test level setting information according to the second example embodiment.

FIG. 7 is a diagram illustrating an example of job flow definition information according to the second example embodiment.

FIG. 8 is a block diagram illustrating a configuration of a test support apparatus according to the second example embodiment.

FIG. 9 is a flowchart illustrating a flow of test support processing according to the second example embodiment.

FIG. 10 is a diagram illustrating an example of a test environment constructed in a case where the test level of the detected AP code according to the second example embodiment is a unit test.

FIG. 11 is a diagram illustrating an example of a test environment constructed in a case where the test level of the detected AP code according to the second example embodiment is a combination test.

### EXAMPLE EMBODIMENT

Hereinafter, example embodiments of the present disclosure will be described in detail with reference to the drawings. In the drawings, the same or corresponding elements are denoted by the same reference numerals, and redundant description is omitted as necessary for clarity of description.

### First Example Embodiment

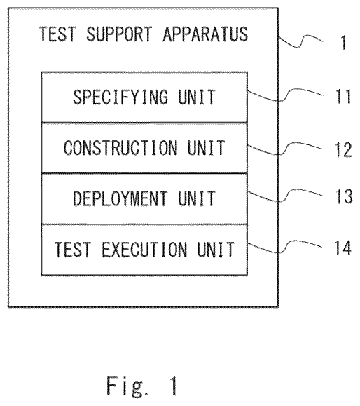

FIG. 1 is a block diagram illustrating the configuration of a test support apparatus 1 according to a first example embodiment. The test support apparatus 1 is an information processing apparatus that constructs a test environment corresponding to a part of a commercial environment of an information system in response to update of the information system (not illustrated) and executes a test regarding update contents in the test environment. The test support apparatus 1 includes a specifying unit 11, a construction unit 12, a deployment unit 13, and a test execution unit 14. Note that the test support apparatus 1 can refer to a database of a built-in storage device (not illustrated) or a connected external storage device (not illustrated). Here, the database is registered by associating each of a plurality of pieces of configuration information constituting the information system with a set of a test program and a test environment corresponding to each piece of configuration information. In addition, the test support apparatus 1 can access the virtual system. Here, the virtual system is an information system in which a logical information resource, for example, a virtual server or the like can be constructed by a virtual container technology or the like.

When detecting some of the plurality of pieces of configuration information, the specifying unit 11 refers to the database and specifies a set of the test program and the test environment associated with the detected configuration information. The construction unit 12 constructs the specified test environment on the virtual system. The deployment unit 13 deploys a partial information system related to the detected configuration information to the constructed test environment. The test execution unit 14 executes the specified test program on the partial information system deployed in the test environment.

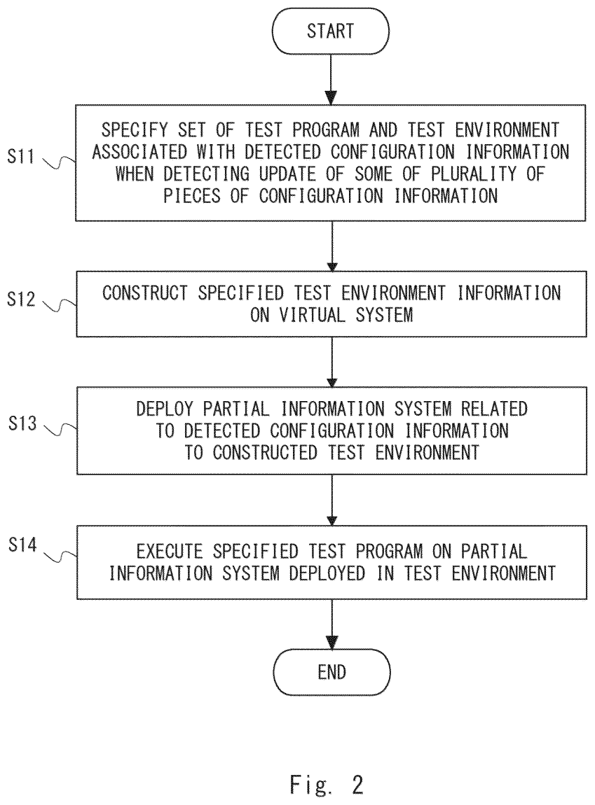

FIG. 2 is a flowchart illustrating a flow of a test support method according to the first example embodiment. First, when detecting some of the plurality of pieces of configuration information, the specifying unit 11 specifies a set of the test program and the test environment associated with the detected configuration information (S11). Next, the construction unit 12 constructs the specified test environment on the virtual system (S12). Then, the deployment unit 13 deploys a partial information system related to the detected configuration information to the constructed test environment (S13). Thereafter, the test execution unit 14 executes the specified test program on the partial information system deployed in the test environment (S14).

As described above, according to the present example embodiment, the test environment necessary for constructing the partial information system related to the updated configuration information is dynamically constructed on the virtual system, and the partial information system is deployed on the test environment. Subsequent to the deployment, the test program associated in advance with the updated configuration information and the test environment is executed on the partial information system on the test environment. Therefore, the resources of the minimum necessary test environment can be allocated, the minimum load module can be loaded, and the test can be performed without constructing all the commercial environments in which the information system is operated. Therefore, it is possible to efficiently construct the test environment of the information system and perform the test.

Note that the test support apparatus 1 includes a processor, a memory, and a storage device as a configuration (not illustrated). In addition, the storage device stores a computer program in which processing of the test support method according to the present example embodiment is implemented. Then, the processor reads a computer program or the like from the storage device into the memory, and executes the computer program. As a result, the processor implements the functions of the specifying unit 11, the construction unit 12, the deployment unit 13, and the test execution unit 14.

Alternatively, each component of the test support apparatus 1 may be realized by dedicated hardware. In addition, some or all of the components of each device may be realized by general-purpose or dedicated circuitry, a processor, or the like, or a combination thereof. These may be configured by a single chip or may be configured by a plurality of chips connected via a bus. Some or all of the components of each device may be realized by a combination of the above-described circuitry or the like and a program. Furthermore, as the processor, a central processing unit (CPU), a graphics processing unit (GPU), a field-programmable gate array (FPGA), a quantum processor (quantum computer control chip), or the like can be used.

### Second Example Embodiment

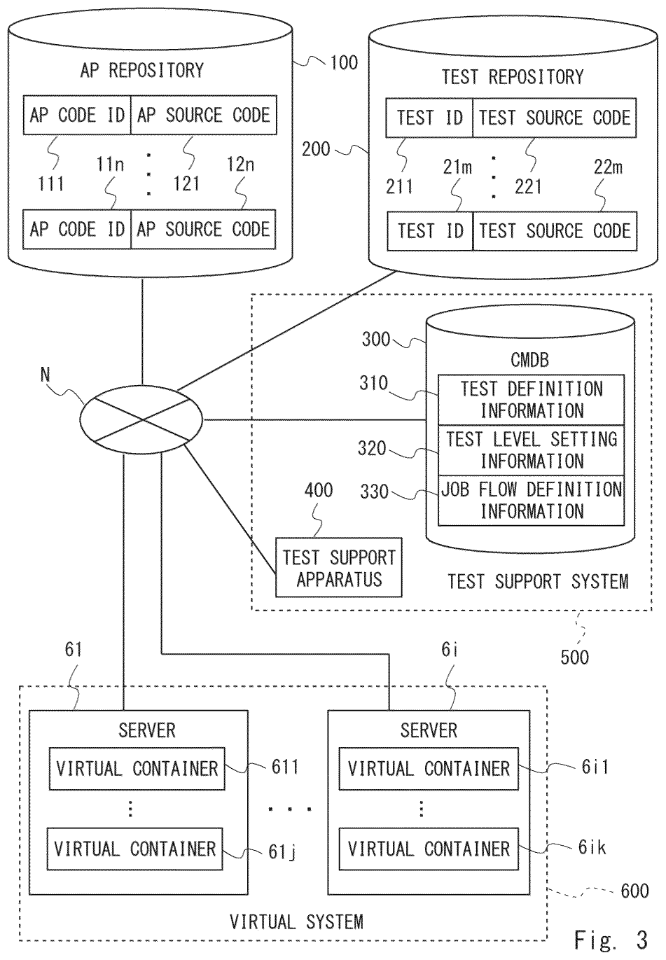

A second example embodiment is a specific example of the first example embodiment described above. FIG. 3 is a block diagram illustrating an overall configuration including a test support system 500 according to the second example embodiment. An application (AP) repository 100, a test repository 200, a configuration management database (CMDB) 300, a test support apparatus 400, and servers 61 to 6i (i is a natural number of 2 or more.) are connected via a network N. The network N is a communication network including a wired or wireless communication line network, a mobile phone line network, and the like. The network N may include the Internet. The communication network may be of any type of communication protocol.

The AP repository 100 is a database that manages a history of source codes, resource data, and the like of applications constituting an operation target information system. The AP repository 100 stores a set of an AP code ID 111 and an AP source code 121, . . . , and a set of an AP code ID 11n (n is a natural number of 2 or more.) and an AP source code 12n. The AP code ID 111 is identification information of the AP source code 121, and the AP code ID 11n is identification information of the AP source code 12n. The AP source code 121 is a set of source program files that provide a single function of the information system. In addition, the AP repository 100 manages update histories of the AP source codes 121 to 12n.

The test repository 200 is a database that manages a history of source codes, resource data, and the like of the test program of the information system. The test repository 200 stores a set of a test ID 211 and a test source code 221, . . . , and a set of a test ID 21m (m is a natural number of 2 or more.) and a test source code 22m. The test ID 211 is identification information of the test source code 221, and the test ID 21m is identification information of the test source code 22m. The test source code 221 is a set of source program files that provide functions of a unit test, a combination test, or a scenario test (comprehensive test) of the information system. In addition, the test repository 200 manages update histories of the test source codes 221 to 22m.

The virtual system 600 includes servers 61 to 6i. The servers 61 to 6i are physical servers. The server 61 includes virtual containers 611 to 61j (j is a natural number of 2 or more.), and the server 6i includes virtual containers 6i1 to 6ik (k is a natural number of 2 or more.). In addition, the virtual system 600 includes a virtual container server (not illustrated). The virtual container server allocates resources in the server 61 to 6i according to an instruction from the outside, and constructs a virtual server container, a virtual DB container, and the like.

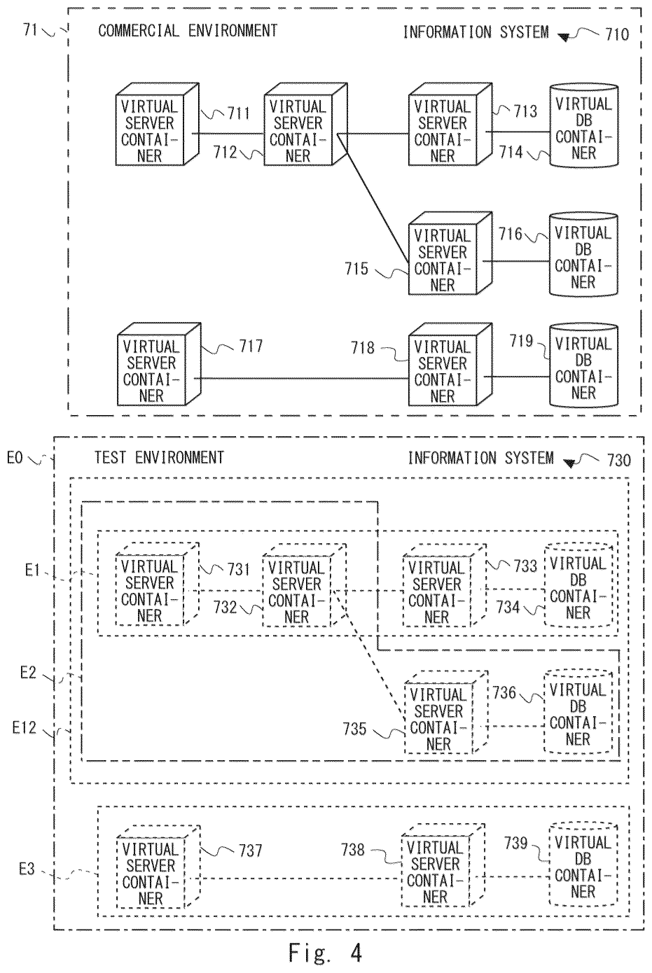

FIG. 4 is a diagram for describing a relationship between the commercial environment 71 and the test environment E0 according to a second example embodiment. In the present example embodiment, it is assumed that the virtual system 600 constructs the commercial environment 71 in which the operation target information system 710 is operated by a set of a plurality of virtual containers. In addition, the virtual system 600 can usually construct a test environment E0 in which a test information system 730 of the information system 710 is operated. That is, the test environment E0 can be constructed on the virtual system 600 as a mirror environment of the commercial environment 71. However, in the present example embodiment, it is assumed that the test environment E0 is not normally constructed in the virtual system 600. This is to suppress cost for securing resources of the virtual container. Note that a virtual container indicated by a broken line in the following drawings indicates that no resource is allocated and is not constructed.

The information system 710 on the commercial environment 71 indicates that each of virtual server containers 711, 712, 713, 715, 717, and 718 and virtual database (DB) containers 714, 716, and 719 is constructed in a physical server. In addition, this example indicates that the virtual server containers 711 and 712 are connected, the virtual server containers 712 and 713 and 715 are connected, the virtual server container 713 and the virtual DB container 714 are connected, and the virtual server container 715 and the virtual DB container 716 are connected. In addition, it is indicated that the virtual server containers 717 and 718 are connected, and the virtual server container 718 and the virtual DB container 719 are connected. However, the configuration of the information system 710 is not limited thereto.

The information system 730 on the test environment E0 indicates that each of the virtual server containers 731, 732, 733, 735, 737, and 738 and the virtual DB containers 734, 736, and 739 can be built on the physical server. Here, the test environment E1 indicates an environment in which a partial information system can be deployed in a case where each of the virtual server containers 731, 732, and 733 and the virtual DB container 734 is constructed in a physical server. In addition, the test environment E2 indicates an environment in which a partial information system can be deployed in a case where each of the virtual server containers 731, 732, and 735 and the virtual DB container 736 is constructed in a physical server. That is, the test environments E1 and E2 indicate that the virtual server containers 731 and 732 are common, but other environments, virtual server containers, and virtual DB containers are different.

The test environment E12 is an environment combining the test environments E1 and E2. That is, the test environment E12 indicates an environment in which a partial information system can be deployed in a case where each of the virtual server containers 731, 732, 733, and 735 and the virtual DB containers 734 and 736 is constructed in a physical server.

The test environment E3 indicates an environment in which a partial information system can be deployed in a case where each of the virtual server containers 737 and 738 and the virtual DB container 739 is constructed in a physical server. That is, the test environment E3 indicates an environment different from the test environments E1, E2, and E12.

Returning to FIG. 3, the description will be continued.

The test support system 500 includes a CMDB300 and a test support apparatus 400. One or both of the CMDB300 and the test support apparatus 400 may be configured by the same hardware. Alternatively, the CMDB300 may be made redundant by a plurality of storages. In addition, the test support apparatus 400 may be made redundant by a plurality of computers, and each functional block may be realized by a plurality of computers.

The CMDB300 is an example of a database in which each of a plurality of pieces of configuration information constituting an information system and a set of a test program and a test environment corresponding to each piece of configuration information are registered in association with each other. Here, the “configuration information” includes design information in the information system, various parameters to be set in the information system, and information (source code, a library, or the like of the program, or a program module generated from the source code, the library, or the like.) regarding software to be implemented in the information system. In the present example embodiment, the configuration information will be described as including at least a program module. The CMDB300 stores test definition information 310, test level setting information 320, and job flow definition information 330.

The test definition information 310 is information defining a set of a test program and a test environment for each AP code ID. In the test definition information 310, a set of a test program and a test environment corresponding to each of a plurality of test levels may be associated with specific configuration information. In the test definition information 310, a set of a test program and a test environment corresponding to specific configuration information may be associated with specific configuration information.

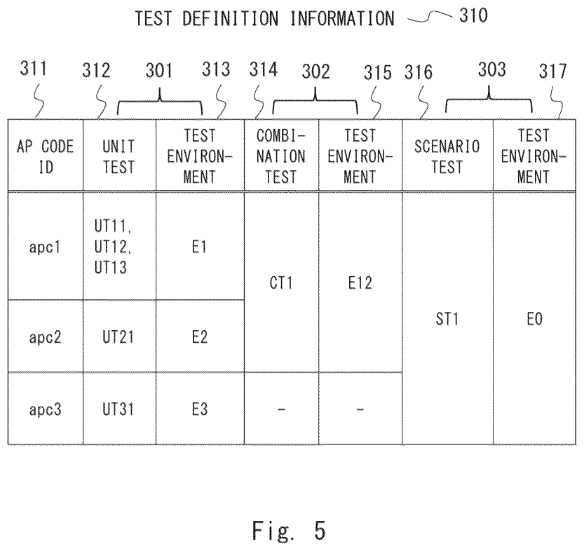

FIG. 5 is a diagram illustrating an example of the test definition information 310 according to the second example embodiment. The test definition information 310 illustrates an example in which a set of a test program and a test environment corresponding to each of a plurality of test levels is associated with each AP code ID. Specifically, a unit test 312, a test environment 313, a combination test 314, a test environment 315, a scenario test 316, and a test environment 317 are associated with each AP code ID 311. Here, the value set to the unit test 312 indicates a list of test IDs of test programs in the unit test. In addition, the value set in the combination test 314 indicates a list of test IDs of test programs in the combination test. In addition, the value set for the scenario test indicates a list of test IDs of test programs in the scenario test.

In addition, the test environment 313 indicates a test environment in the unit test 312, the test environment 315 indicates a test environment in the combination test 314, and the test environment 317 indicates a test environment in the scenario test 316. That is, the unit test 312 and the test environment 313 are a unit test set 301, the combination test 314 and the test environment 315 are a combination test set 302, and the scenario test 316 and the test environment 317 are a scenario test set 303. Here, the unit test 312, the combination test 314, and the scenario test 316 indicate test levels. Further, in this example, the AP code ID “apc1” indicates that the test IDs of the unit test are “UT11”, “UT12”, and “UT13”, and the test environment is “E1”. Further, the AP code ID “apc1” indicates that the test ID of the combination test is “CT1” and the test environment is “E12”. Further, the AP code ID “apc1” indicates that the test ID of the scenario test is “ST1” and the test environment is “E0”.

Furthermore, in this example, it is indicated that the unit test set 301 is different in AP code IDs “apc1”, “apc2”, and “apc3”. That is, it is indicated that, in order to execute the unit test “UT21”, the load module of “apc2” and the test environment “E2” are necessary, but the load modules of “apc1” and “apc3” and the test environments “E1” and “E3” are unnecessary.

Further, in this example, it is indicated that the combination test set 302 is common to the AP code IDs “apc1” and “apc2” and is not defined in “apc3”. That is, it is indicated that in order to perform the combination test “CT1”, even when only one of “apc1” and “apc2” is updated, both the load modules of “apc1” and “apc2” and the test environment “E12” are required.

Further, in this example, it is indicated that the scenario test set 303 is common to the AP code IDs “apc1”, “apc2”, and “apc3”. That is, it is indicated that all load modules of “apc1”, “apc2”, and “apc3” and test environment “E0” are required to execute the scenario test “ST1”.

Note that the test IDs defined in the above-described unit test 312, the combination test 314, and the scenario test 316 correspond to one or more of the above-described test IDs 211 and the like in the test repository 200. In addition, E0, E1, E2, E12, and E3 set in the above-described test environments 313, 315, and 317 are virtual containers defined in FIG. 4. For example, in the test environment E1, it is defined that the virtual server containers 731, 732, and 733 and the virtual DB container 734 are connected in this order.

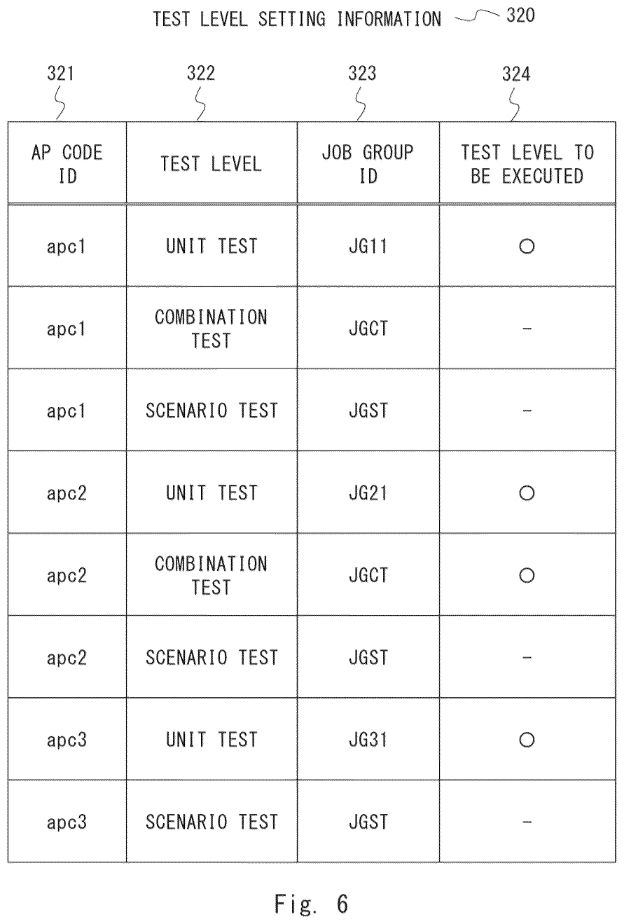

FIG. 6 is a diagram illustrating an example of the test level setting information 320 according to the second example embodiment. The test level setting information 320 is information in which a test level to be executed is set for each AP code ID. In other words, the test level setting information 320 is information in which a test level to be executed is further associated with specific configuration information. Specifically, a job group ID 323 and a test level 324 to be executed are set for each set of the AP code ID 311 and the test level 322. The test level 322 indicates the type and level of tests such as a unit test, a combination test, and a scenario test. The job group ID 323 is identification information of a job group that is a set of jobs, that is, a job flow. The test level 324 to be executed is information indicating whether or not the associated test level is to be executed in a specific AP code ID. In this example, “○” indicates that it should be executed, and “−” indicates that it should not be executed, that is, it is not necessary to execute. Note that the test level setting information 320 may register a set of the AP code ID 311, the test level 322, and the job group ID 323 of the test level to be executed instead of the item of the test level 324 to be executed.

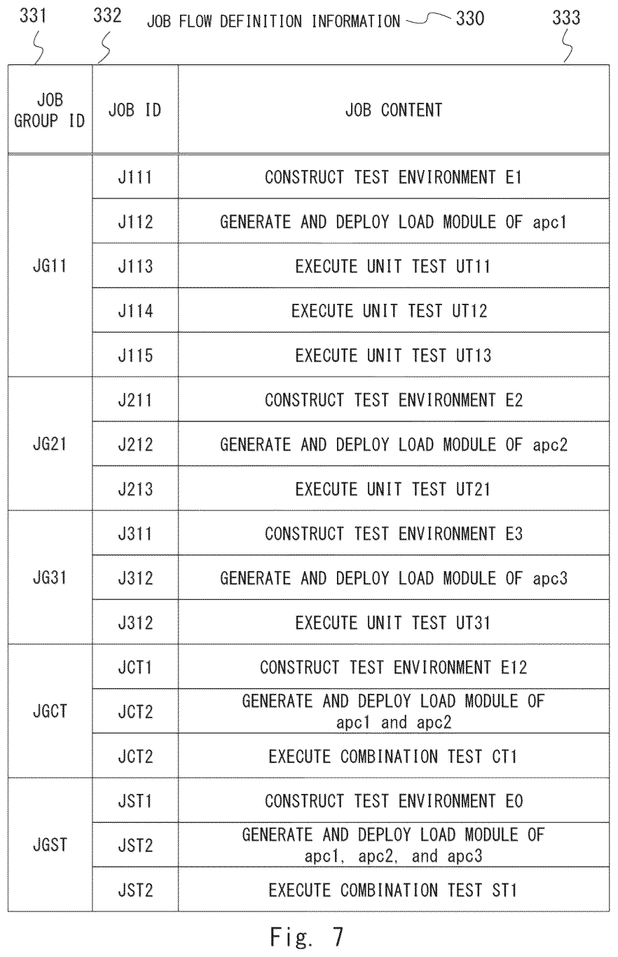

FIG. 7 is a diagram illustrating an example of the job flow definition information 330 according to the second example embodiment. The job flow definition information 330 is information that defines a set of sets of the job ID 332 and the job content 333 for each job group ID 331. For example, the job group ID 331 “JG11” indicates that the jobs are executed in the order of the job IDs 332 “J111”, “J112”, “J113”, “J114”, and “J115”. For example, “J111” indicates the job content “construct test environment E1”. “J112” indicates the job content “generate load module of apc1”. “J113” indicates the job content “execute the unit test UT11”. “J114” indicates the job content “execute the unit test UT12”. “J115” indicates the job content “execute the unit test UT13”.

Note that “J113”, “J212”, “J312”, “JCT2”, and “JST2” may generate a load module corresponding to an AP code ID specified and designated by the test support apparatus 400 without fixing the AP code ID.

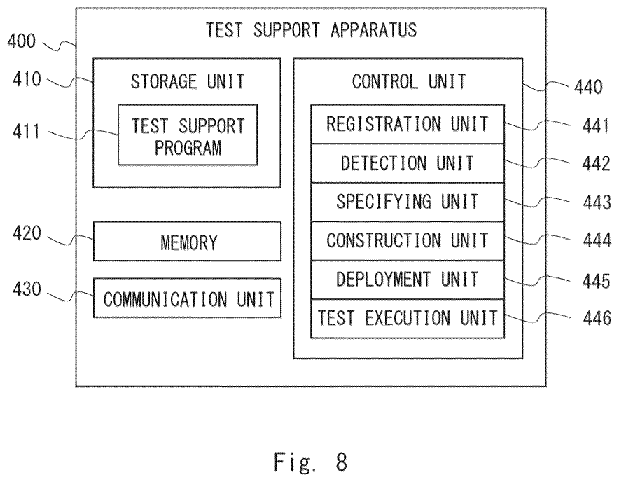

FIG. 8 is a block diagram illustrating a configuration of the test support apparatus 400 according to the second example embodiment. The test support apparatus 400 includes a storage unit 410, a memory 420, a communication unit 430, and a control unit 440. The storage unit 410 is an example of a storage device such as a hard disk or a flash memory. The storage unit 410 stores a test support program 411. A test support program 411 is a computer program in which test support processing and the like according to the second example embodiment are implemented.

The memory 420 is a volatile storage device such as a random access memory (RAM), and is a storage area for temporarily holding information during the operation of the control unit 440. The communication unit 430 is a communication interface between the inside and the outside of the test support apparatus 400.

The control unit 440 is a processor that controls each component of the test support apparatus 400, that is, a control apparatus. The control unit 440 reads the test support program 411 from the storage unit 410 into the memory 420 and executes the test support program 411. As a result, the control unit 440 implements the functions of a registration unit 441, a detection unit 442, a specifying unit 443, a construction unit 444, a deployment unit 445, and a test execution unit 446.

The registration unit 441 registers each of a plurality of pieces of configuration information constituting the information system and a set of a test program and a test environment corresponding to each piece of configuration information in the CMDB300 in association with each other. In addition, the registration unit 441 registers a set of a test program and a test environment corresponding to the specific configuration information and corresponding to each of the plurality of test levels in the CMDB300 in association with the specific configuration information. In addition, the registration unit 441 further associates a test level to be executed with the specific configuration information, and registers the test level in the CMDB300. Specifically, the registration unit 441 registers the test definition information 310, the test level setting information 320, and the job flow definition information 330 in the CMDB300 according to information input from an administrator terminal (not illustrated) operated by an administrator who manages a test of an information system. Note that the registration unit 441 may register the test source code input from the administrator terminal in the test repository 200.

The detection unit 442 monitors the AP repository 100 and detects that a part of the AP source codes 121 to 12n has been updated. For example, the detection unit 442 may periodically check the update state of the AP repository 100. Alternatively, the detection unit 442 may detect the update at the time of synchronization processing between the AP repository 100 and a local repository (not illustrated). When detecting the update, the detection unit 442 notifies the specifying unit 443 of the updated AP code ID.

The specifying unit 443 is an example of the specifying unit 11 described above. When the detection unit 442 detects that a part of the configuration information is updated, the specifying unit 443 refers to the CMDB300 and specifies a set of the test program and the test environment associated with the detected configuration information. Specifically, in a case where the updated AP code ID is notified from the detection unit 442, the specifying unit 443 identifies a record in which the test level 324 to be executed for the notified AP code ID is “○” from the test level setting information 320, and identifies the test level 322 and the job group ID 323 of the record. Then, the specifying unit 443 specifies the notified AP code ID, the test ID of the specified test level, and the test environment from the test definition information 310.

Further, the specifying unit 443 specifies a set of another configuration information and another test environment related to the configuration information with reference to the CMDB300. Specifically, the specifying unit 443 specifies a test level associated with the detected configuration information with reference to the CMDB300, and specifies a set of a test program and a test environment corresponding to the test level as a set of another configuration information and another test environment related to the configuration information. For example, in a case where the notified AP code ID “apc2” and the specified test level is the combination test “CT1”, the specifying unit 443 specifies another AP code ID “apc1” and another test environment “E2” necessary for executing “CT1” from the test definition information 310. This is because the test environment “E2” is included in “E12”.

The construction unit 444 is an example of the construction unit 12 described above. The construction unit 444 constructs the specified test environment on the virtual system 600. The construction unit 444 preferably discards the test environment after executing the test program. As a result, the test environment can be temporarily used, and the use time (rental time) can be suppressed. Therefore, the maintenance cost of the test environment can be reduced.

The deployment unit 445 is an example of the deployment unit 13 described above. The deployment unit 445 deploys a partial information system related to the detected configuration information to the constructed test environment. Specifically, the deployment unit 445 acquires an AP source code corresponding to the detected AP code ID from the AP repository 100, and generates a load module. Here, the generated load module is not an application of the entire information system, but an application corresponding to a partial information system related to update. Then, the deployment unit 445 deploys the generated load module to the constructed test environment.

Further, when another configuration information related to the configuration information is specified, the deployment unit 445 deploys a program module corresponding to the detected configuration information and a program module corresponding to the specified other configuration information together as a partial information system to the constructed test environment.

The test execution unit 446 is an example of the test execution unit 14 described above. The test execution unit 446 executes the specified test program on the partial information system deployed in the test environment.

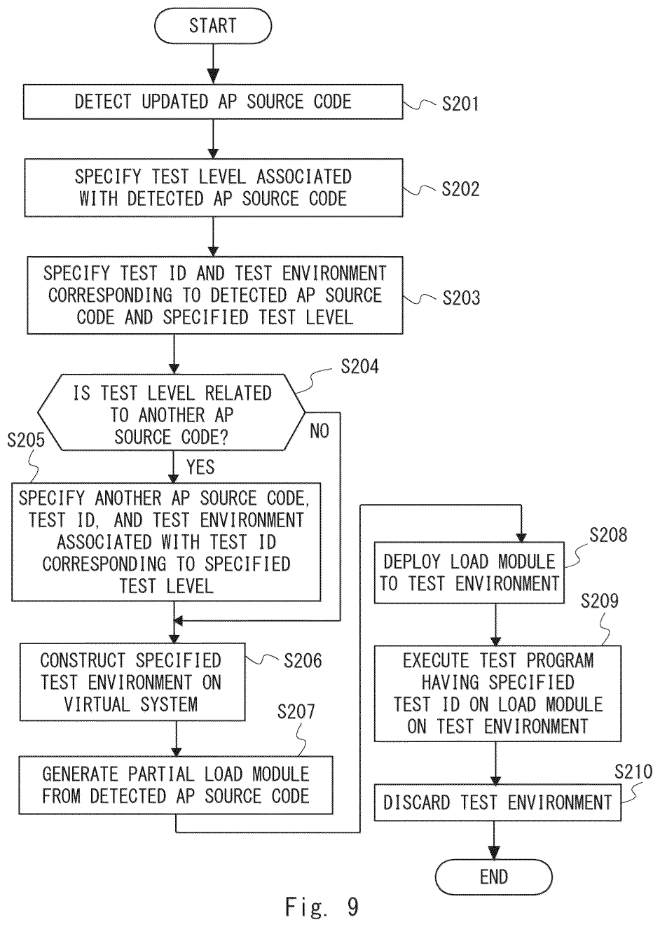

FIG. 9 is a flowchart illustrating a flow of test support processing according to the second example embodiment. First, a developer terminal (not illustrated) operated by a developer or the like of the information system corrects an AP source code corresponding to a part of an application program constituting the information system, and registers the corrected AP source code in the AP repository 100.

Then, the detection unit 442 monitors the AP repository 100 and detects the updated AP source code (S201). The detection unit 442 notifies the specifying unit 443 of the AP code ID corresponding to the detected AP source code. Here, it is assumed that the AP code ID “apc1” is notified.

In response to this, the specifying unit 443 specifies a test level associated with the detected AP source code (S202). For example, the specifying unit 443 specifies a record in which the test level 324 to be executed for the AP code ID “apc1” notified from the detection unit 442 is “○” from the test level setting information 320. Then, the specifying unit 443 specifies the test level 322 “unit test” and the job group ID 323 “JG11” of the record.

Next, the specifying unit 443 specifies a test ID and a test environment corresponding to the detected AP source code and the specified test level (S203). For example, the specifying unit 443 specifies the unit tests 312 “UT11”, “UT12”, and “UT13” of the AP code ID “apc1” and the test environment 313 “E1” from the test definition information 310.

Then, the specifying unit 443 determines whether the test level is related to another AP source code (S204). For example, since the unit test of the AP code ID “apc1” is not common to another AP code ID from the test definition information 310, the specifying unit 443 determines that the test level is not related to the other AP source code (NO in S204).

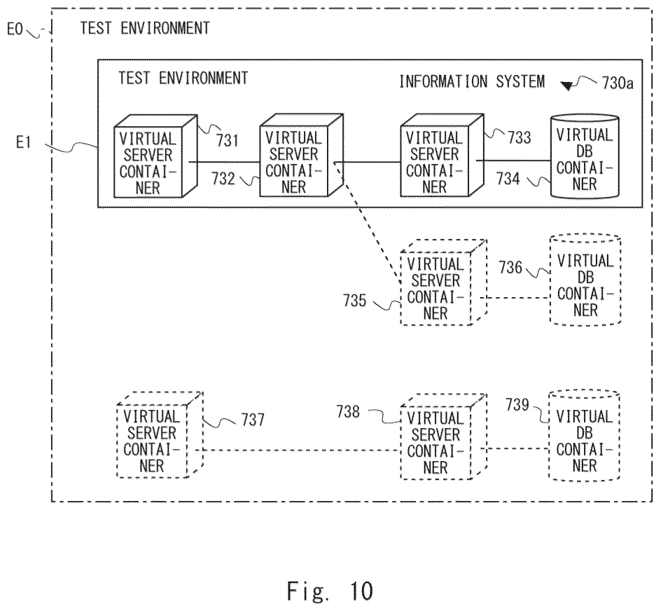

Therefore, the construction unit 444 constructs the specified test environment “E1” on the virtual system 600 (S206). FIG. 10 is a diagram illustrating an example of a test environment constructed in a case where the test level of the detected AP code according to the second example embodiment is the unit test. Here, the construction unit 444 allocates four virtual containers on the virtual system 600, and constructs the virtual server containers 731, 732, and 733 and the virtual DB container 734 as the test environment E1. Meanwhile, at this time, it is indicated that the virtual server containers 735, 737, and 738 and the virtual DB containers 736 and 739 are not constructed.

Returning to FIG. 9, the description will be continued.

Subsequently, the deployment unit 445 generates a partial load module from the detected AP source code (S207). For example, the deployment unit 445 acquires an AP source code corresponding to the AP code ID “apc1” from the AP repository 100, and generates a partial load module in the information system from the AP source code. Then, deployment unit 445 deploys the generated load module to test environment “E1” (S208). For example, the information system 730a in FIG. 10 is deployed in a test environment “E1”.

Then, the test execution unit 446 executes a test program having the specified test ID on the load module on the test environment “E1” (S209). As a result, the test execution unit 446 acquires the execution result, verifies the execution result, and determines whether the test is successful.

Note that, in a case where the above-described Steps S206 to S209 are executed using the job flow definition information 330, the steps are as follows. First, the specifying unit 443 specifies “J115” from the job ID “J111” associated with the job group ID “JG11” specified in Step S202 from the job flow definition information 330. Then, the construction unit 444 constructs the test environment E1 on the virtual system 600 as “J111” (S206). Specifically, the construction unit 444 allocates (dispenses) the four virtual containers defined in the test environment E1 onto the virtual system 600, and constructs the virtual server containers 731, 732, and 733 and the virtual DB container 734. Next, the deployment unit 445 generates a load module corresponding to the AP code ID “apc1” as “J112” (S207) and deploys the load module on the test environment E1 (S208).

Thereafter, the test execution unit 446 acquires, as “J113”, a test code corresponding to the test ID “UT11” of the unit test from the test repository 200. The test execution unit 446 may compile, build, and the like the acquired test code as necessary to generate an executable program module (test program). Then, the test execution unit 446 executes the test code or the generated program module on the load module deployed on the test environment E1. Similarly, the test execution unit 446 executes, as “J114”, the test ID “UT12” of the unit test in the same manner as described above. Thereafter, the test execution unit 446 executes, as “J115”, the test ID “UT13” of the unit test in the same manner as described above.

Thereafter, the construction unit 444 discards the constructed test environment “E1” (S210). Note that, in the job flow definition information 330, discard processing of the constructed test environment may be added to the last job ID of each job group ID.

Next, a case where the test level of the detected AP code is the combination test will be described. Here, it is assumed that the AP code ID “apc2” corresponding to the updated AP source code is notified. In this case, the specifying unit 443 specifies two records in which the test level 324 to be executed for the AP code ID “apc2” is “○” from the test level setting information 320. Then, the specifying unit 443 specifies “unit test” and “JG21” and “combination test” and “JGCT” as the test level 322 and the job group ID 323 of each record (S202). Then, the specifying unit 443 specifies the unit test 312 “UT21” and the test environment 313 “E2” of the AP code ID “apc2” and the combination test 314 “CT1” and the test environment 315 “E12” from the test definition information 310 (S203).

Here, the specifying unit 443 determines that the test level is related to another AP source code (YES in S204) from the test definition information 310. This is because the combination test of the AP code ID “apc2” is common to the other AP code ID “apc1”. Therefore, the specifying unit 443 specifies another AP source code, a test ID, and a test environment associated with the test ID corresponding to the specified test level (S205). Specifically, the specifying unit 443 specifies another AP code ID “apc1”, test IDs “UT11”, “UT12”, and “UT13” associated with the test ID “CT1” of the combination test, and the test environment “E1”. However, since the AP code ID “apc1” is not updated, the specifying unit 443 does not need to specify the test IDs “UT11”, “UT12”, and “UT13”. That is, the unit test of the AP code ID “apc1” that is not updated may not be executed. Furthermore, in this example, since “E1” and “E2” are included in the test environment “E12” of the combination test “CT1”, the test environment to be constructed may be only “E12”.

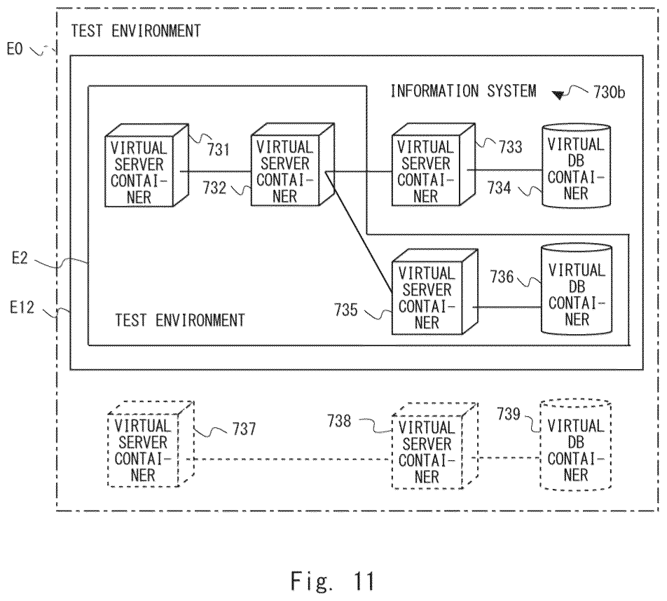

Subsequently, the construction unit 444 constructs the specified test environment “E12” on the virtual system 600 (S206). FIG. 11 is a diagram illustrating an example of a test environment constructed in a case where the test level of the detected AP code according to the second example embodiment is the combination test. Here, the construction unit 444 allocates six virtual containers on the virtual system 600, and constructs the virtual server containers 731, 732, 733, and 735 and the virtual DB containers 734 and 736 as the test environment E12. It is indicated that the test environment E2 is also constructed. Meanwhile, at this time, it is indicated that the virtual server containers 737 and 738 and the virtual DB container 739 are not constructed.

Returning to FIG. 9, the description will be continued.

Subsequently, the deployment unit 445 acquires AP source codes corresponding to the AP code IDs “apc1” and “apc2” from the AP repository 100, and generates a partial load module in the information system from the AP source codes (S207). Then, deployment unit 445 deploys the generated load module to the test environment “E12” (S208). For example, the information system 730b of FIG. 11 is deployed in a test environment “E12”. Then, the test execution unit 446 executes the test program having the specified test ID on the load module on the test environment “E12” (S209). In this example, the test execution unit 446 executes the unit test “UT21” on the load module on the test environment “E2”. When the execution result of “UR21” is successful, the test execution unit 446 executes a combination test “CT1” on the load module on the test environment “E12”.

Note that, in a case where Steps S206 to S209 described above are executed using the job flow definition information 330, the following may be performed. For example, “JG21” is executed first, and the test environment E2 is discarded. Thereafter, “JGCT” is executed, and the test environment E12 is discarded. Alternatively, “JCT1” and “JCT2” in “JGCT” may be executed, “J213” corresponding to the unit test of “apc2” may be executed, then “JGCT” corresponding to the combination test may be executed, and test environment E12 may be discarded.

In addition, in the test level setting information 320, in a case where the test level 324 is a test level to be executed only by the combination test for the AP code ID “apc2”, only the job group ID “JGCT” is executed. Also in this case, for the combination test, load modules corresponding to “apc1” and “apc2” are deployed, but “apc3” is not deployed and the test environment “E3” is not constructed.

Therefore, according to the present example embodiment, at the time of partial update of an application, a partial test environment is constructed as compared with a commercial environment, a partial load module is generated and deployed, and a test program of a portion corresponding to an updated function is executed. Therefore, it is possible to efficiently construct the test environment of the information system and perform the test.

### Other Example Embodiments

In the above-described example, the program includes a group of instructions (or software code) for causing a computer to perform one or more functions described in the example embodiments when being read by the computer. The program may be stored in a non-transitory computer-readable medium or a tangible storage medium. By way of example, and not limitation, the computer-readable medium or tangible storage medium includes random-access memory (RAM), read-only memory (ROM), flash memory, solid-state drive (SSD) or other memory technology, CD-ROM, digital versatile disc (DVD), Blu-ray® disc or other optical disk storage, magnetic cassettes, magnetic tape, magnetic disk storage, or other magnetic storage devices. The program may be transmitted on a transitory computer-readable medium or a communication medium. By way of example, and not limitation, the transitory computer-readable medium or communication medium includes electrical, optical, acoustic, or other forms of propagated signals.

Note that the present disclosure is not limited to the above example embodiments, and can be appropriately changed without departing from the gist. Furthermore, the present disclosure may be implemented by appropriately combining the respective example embodiments.

Some or all of the above example embodiments may be described as the following Supplementary Notes, but are not limited to the following.

### (Supplementary Note A1)

A test support apparatus including:
a specifying means for, when an update of some of a plurality of pieces of configuration information constituting an information system is detected, referring to a database in which each of the plurality of pieces of configuration information constituting the information system and a set of a test program and a test environment corresponding to each piece of the configuration information are registered in association with each other and specifying the set of the test program and the test environment associated with the detected configuration information;
a construction means for constructing the specified test environment on a virtual system;
a deployment means for deploying a partial information system related to the detected configuration information to the constructed test environment; and
a test execution means for executing the specified test program on the partial information system deployed in the test environment.

### (Supplementary Note A2)

The test support apparatus according to Supplementary Note A1, in which
the specifying means further specifies a set of another configuration information and another test environment related to the configuration information with reference to the database, and
the deployment means deploys a program module corresponding to the detected configuration information and a program module corresponding to the specified other configuration information together as the partial information system to the constructed test environment.

### (Supplementary Note A3)

The test support apparatus according to Supplementary Note A2, in which
in the database,
a set of a test program and a test environment corresponding to each of a plurality of test levels is associated with specific configuration information, and
a test level to be executed is further associated with the specific configuration information, and
the specifying means
specifies the test level associated with the detected configuration information with reference to the database, and specifies a set of a test program and a test environment corresponding to the test level as a set of another configuration information and another test environment related to the configuration information.

### (Supplementary Note A4)

The test support apparatus according to any one of Supplementary Notes A1 to A3, in which the construction means discards the test environment after execution of the test program.

### (Supplementary Note A5)

The test support apparatus according to any one of Supplementary Notes A1 to A4, in which the configuration information includes at least a program module.

### (Supplementary Note B1)

A test support system including:
a database in which each of a plurality of pieces of configuration information constituting an information system and a set of a test program and a test environment corresponding to each piece of configuration information are registered in association with each other; and
a test support apparatus connected to the database,
in which the test support apparatus includes
a specifying means for, when an update of some of the plurality of pieces of configuration information is detected, referring to the database to specify a set of a test program and a test environment associated with the detected configuration information,
a construction means for constructing the specified test environment on a virtual system,
a deployment means for deploying a partial information system related to the detected configuration information to the constructed test environment, and
a test execution means for executing the specified test program on the partial information system deployed in the test environment.

### (Supplementary Note B2)

The test support system according to Supplementary Note B1, in which
the specifying means further specifies a set of another configuration information and another test environment related to the configuration information with reference to the database, and
the deployment means deploys a program module corresponding to the detected configuration information and a program module corresponding to the specified other configuration information together as the partial information system to the constructed test environment.

### (Supplementary Note C1)

A test support method including:
referring, when an update of some of the plurality of pieces of configuration information constituting the information system is detected, to a database in which each of a plurality of pieces of configuration information constituting an information system and a set of a test program and a test environment corresponding to each piece of the configuration information are registered in association with each other and specifying the set of the test program and the test environment associated with the detected configuration information;
constructing the specified test environment on a virtual system;
deploying a partial information system related to the detected configuration information to the constructed test environment; and
executing the specified test program on the partial information system deployed in the test environment.

### (Supplementary Note D1)

A non-transitory computer-readable medium storing a test support program for causing a computer to execute:
specifying processing of, when an update of some of a plurality of pieces of configuration information constituting an information system is detected, referring to a database in which each of the plurality of pieces of configuration information constituting the information system and a set of a test program and a test environment corresponding to each piece of the configuration information are registered in association with each other and specifying the set of the test program and the test environment associated with the detected configuration information;
construction processing of constructing the specified test environment on a virtual system;
deployment processing of deploying a partial information system related to the detected configuration information to the constructed test environment; and
test execution processing of executing the specified test program on the partial information system deployed in the test environment.

Although the present invention has been described with reference to the example embodiments (and examples), the present invention is not limited to the above example embodiments (and examples). Various modified examples that can be understood by those skilled in the art can be made to the configuration and details of the present invention within the scope of the present invention.

### REFERENCE SIGNS LIST

1 TEST SUPPORT APPARATUS
11 SPECIFYING UNIT
12 CONSTRUCTION UNIT
13 DEPLOYMENT UNIT
14 TEST EXECUTION UNIT
N NETWORK
100 AP REPOSITORY
111 AP CODE ID
11n AP CODE ID
121 AP SOURCE CODE
12n AP SOURCE CODE
200 TEST REPOSITORY
211 TEST ID
21m TEST ID
221 TEST SOURCE CODE
22m TEST SOURCE CODE
300 CMDB
310 TEST DEFINITION INFORMATION
311 AP CODE ID
312 UNIT TEST
313 TEST ENVIRONMENT
314 COMBINATION TEST
315 TEST ENVIRONMENT
316 SCENARIO TEST
317 TEST ENVIRONMENT
301 UNIT TEST SET
302 COMBINATION TEST SET
303 SCENARIO TEST SET
320 TEST LEVEL SETTING INFORMATION
321 AP CODE ID
322 TEST LEVEL
323 JOB GROUP ID
324 TEST LEVEL TO BE EXECUTED
330 JOB FLOW DEFINITION INFORMATION
331 JOB GROUP ID
332 JOB ID
333 JOB CONTENT
400 TEST SUPPORT APPARATUS
410 STORAGE UNIT
411 TEST SUPPORT PROGRAM
420 MEMORY
430 COMMUNICATION UNIT
440 CONTROL UNIT
441 REGISTRATION UNIT
442 DETECTION UNIT
443 SPECIFYING UNIT
444 CONSTRUCTION UNIT
445 DEPLOYMENT UNIT
446 TEST EXECUTION UNIT
500 TEST SUPPORT SYSTEM
600 VIRTUAL SYSTEM
61 SERVER
611 VIRTUAL CONTAINER
61j VIRTUAL CONTAINER
6i SERVER
6i1 VIRTUAL CONTAINER
6ik VIRTUAL CONTAINER
71 COMMERCIAL ENVIRONMENT
710 INFORMATION SYSTEM
711 VIRTUAL SERVER CONTAINER
712 VIRTUAL SERVER CONTAINER
713 VIRTUAL SERVER CONTAINER
714 VIRTUAL DB CONTAINER
715 VIRTUAL SERVER CONTAINER
716 VIRTUAL DB CONTAINER
717 VIRTUAL SERVER CONTAINER
718 VIRTUAL SERVER CONTAINER
719 VIRTUAL DB CONTAINER
E0 TEST ENVIRONMENT
E1 TEST ENVIRONMENT
E2 TEST ENVIRONMENT
E12 TEST ENVIRONMENT
E3 TEST ENVIRONMENT
730 INFORMATION SYSTEM
730a INFORMATION SYSTEM
730b INFORMATION SYSTEM
731 VIRTUAL SERVER CONTAINER
732 VIRTUAL SERVER CONTAINER
733 VIRTUAL SERVER CONTAINER
734 VIRTUAL DB CONTAINER
735 VIRTUAL SERVER CONTAINER
736 VIRTUAL DB CONTAINER
737 VIRTUAL SERVER CONTAINER
738 VIRTUAL SERVER CONTAINER
739 VIRTUAL DB CONTAINER

What is claimed is:

1. A test support apparatus comprising:
at least one storage device configured to store instructions; and
at least one processor configured to execute the instructions to:
when an update of some of a plurality of pieces of configuration information constituting an information system is detected, refer to a database in which each of the plurality of pieces of configuration information constituting the information system and a set of a test program and a test environment corresponding to each piece of the configuration information are registered in association with each other and specify the set of the test program and the test environment associated with the detected configuration information;
construct the specified test environment on a virtual system;
deploy a partial information system related to the detected configuration information to the constructed test environment; and
execute the specified test program on the partial information system deployed in the test environment.

2. The test support apparatus according to claim 1, wherein the at least one processor is further configured to execute the instructions to:
specify a set of another configuration information and another test environment related to the configuration information with reference to the database, and
deploy a program module corresponding to the detected configuration information and a program module corresponding to the specified other configuration information together as the partial information system to the constructed test environment.

3. The test support apparatus according to claim 2, wherein
in the database,
a set of a test program and a test environment corresponding to each of a plurality of test levels is associated with specific configuration information, and
a test level to be executed is further associated with the specific configuration information, and
wherein the at least one processor is further configured to execute the instructions to:
specify the test level associated with the detected configuration information with reference to the database, and specify a set of a test program and a test environment corresponding to the test level as a set of another configuration information and another test environment related to the configuration information.

4. The test support apparatus according to claim 1, wherein the at least one processor is further configured to execute the instructions to:
discard the test environment after execution of the test program.

5. The test support apparatus according to claim 1, wherein the configuration information includes at least a program module.

6-7. (canceled)

8. A test support method comprising:
referring, when an update of some of a plurality of pieces of configuration information constituting an information system is detected, to a database in which each of the plurality of pieces of configuration information constituting the information system and a set of a test program and a test environment corresponding to each piece of the configuration information are registered in association with each other and specifying the set of the test program and the test environment associated with the detected configuration information;
constructing the specified test environment on a virtual system;
deploying a partial information system related to the detected configuration information to the constructed test environment; and
executing the specified test program on the partial information system deployed in the test environment.

9. A non-transitory computer-readable medium storing a test support program for causing a computer to execute:
specifying processing of, when an update of some of a plurality of pieces of configuration information constituting an information system is detected, referring to a database in which each of the plurality of pieces of configuration information constituting the information system and a set of a test program and a test environment corresponding to each piece of the configuration information are registered in association with each other and specifying the set of the test program and the test environment associated with the detected configuration information;
construction processing of constructing the specified test environment on a virtual system;
deployment processing of deploying a partial information system related to the detected configuration information to the constructed test environment; and
test execution processing of executing the specified test program on the partial information system deployed in the test environment.
